(19) United States
(12) Patent Application Publication
(10) Pub. No.: US 2020/0342834 A1
(43) Pub. Date: Oct. 29, 2020

(54) Picks for Guitar Performance and Manufacturing Method Thereof

(71) Applicant: Jong Cheoul Choi, Incheon (KR)

(72) Inventor: Jong Cheoul Choi, Incheon (KR)

(21) Appl. No.: 16/397,144

(22) Filed: Apr. 29, 2019

(51) Int. Cl. G10D 3/16; B29C 45/14

(52) U.S. Cl. CPC G10D 3/163; B29C 2045/14147; B29C 2045/14122; B29C 45/14065

(57) ABSTRACT

Provided is a pick for guitar performance and manufacturing method thereof. The method of manufacturing a pick for guitar performance comprises preparing a first mold and a second mold disposed to face each other in a horizontal direction, mounting an inner magnet in a first holder pin formed in a central portion of the first mold, disposing the inner magnet to support the inner magnet by using first to third support pins formed in the first mold and disposed in a triangular shape at intervals of 120° around the first holder pin based on the first holder pin, operating the second mold so that a second holder pin formed at a central portion of the second mold contacts the first holder pin by moving the second mold in a horizontal direction, operating the fourth to sixth support pins formed in the second mold to support the inner magnet by being disposed in a triangular shape at intervals of 120° around the second holder pin based on the second holder pin according to a horizontal movement of the second mold, injecting resin into a resin inlet formed along a central portion of the first mold after the first mold and the second mold contact each other, and injecting the injected resin to surround the inner magnet, and solidifying the resin in a liquid state to complete the pick in which the inner magnet is disposed therein.

### TECHNICAL FIELD

The present invention relates to a pick for guitar performance and a manufacturing method thereof. More specifically, the present invention relates to a pick for guitar performance and a manufacturing method thereof, the pick will reduce the risk of loss of the pick by using a metal of the guitar string and a magnetic body formed at the peg of the rear surface of the guitar head, forming a magnet inside the pick, and keeping the pick on the magnetic body in a detachable manner, and keeping the extra picks on the rear surface of the guitar head.

### BACKGROUND

The guitar is a representative induced expression musical instrument that is most widely used in today, and includes a head, a neck, and a body. In addition, the guitar has six strings. With respect to the guitar, the player holds the string in a specific code in the neck part and bounces it in various ways in the body part, thereby making a desired sound and playing the sound.

The guitar comprises: a head having the peg to tune a plurality of strings; a neck having frets to separate a fingerboard that fingers to make a sound; and a body including a echo canal and a sound hole for sound. In the guitar configured as described above, by flicking the string with a finger or the like, the sound is generated through vibration inside the echo canal. In other words, guitar performance is relatively easy, and various range of note and rhythm can be expressed, and thus people have many interests for guitar performance.

In addition, when the player flicks the string, a finger or a nail is used or a pick is used. Here, the pick refers to a tool used to perform the guitar, i.e., a small piece for flicking a string. The picks used in the above guitar may include three kinds of flat picks, thumb picks, and finger picks, and the materials may be made of the most of the celluloid, but may be made of the metal, the turtle shells, and the nylon.

The flat pick is flat and has various shapes and sizes, but is distinguished by heavy(hard), medium, and soft(swing) by intensity(thickness). In addition, the flat pick is usually held using a thumb and an index finger. The thumb pick may be used in the thumb and it may generate a clear and strong sound by using it. In addition, the finger pick is fitted into the index finger and the center finger by using a method such as a thumb pick.

Among these guitar picks, a flat pick is most commonly used, and a flat pick is formed in a thin plate shape, and is held by a thumb and an index finger, and make strings be flicked based on a specific rhythm. In addition, the flat picks are formed to have various thicknesses such as 0.5 mm, 0.7 mm, 0.88 mm, and 1.5 mm, and sounds that are different according to the thickness are differently implemented. For example, when a thin pick such as 0.5 mm is used for guitar performance, the high tone is emphasized. On the other hand, when a relatively thick pick such as 1.5 mm is used, the low tone is emphasized while the guitar sound is softened. In other words, guitar sounds have a stable feeling.

As described above, sounds may be differently implemented according to the type of a pick used to play the guitar in addition to the skill of the player. For this reason, the choice of the pick is also taken as an important factor.

### SUMMARY

The present invention has been made in an effort to provide a pick for guitar performance and a method for manufacturing the same, the pick will reduce the risk of loss of the pick by using a metal of the guitar string and a magnetic body formed at the peg of the rear surface of the guitar head, forming a magnet inside the pick, and keeping the pick on the magnetic body in a detachable manner, and keeping the extra picks on the rear surface of the guitar head.

The present invention has been made in efforts of the above problems, it is to be understood that the invention is not limited to the disclosed embodiments, it can be extended in various ways.

According to an aspect of the present inventions, there is provided a method of manufacturing a pick for guitar performance, the method comprising: preparing a first mold and a second mold disposed to face each other in a horizontal direction; mounting an inner magnet in a first holder pin formed in a central portion of the first mold; disposing the inner magnet to support the inner magnet by using first to third support pins formed in the first mold and disposed in a triangular shape at intervals of 120° around the first holder pin based on the first holder pin; operating the second mold so that a second holder pin formed at a central portion of the second mold contacts the first holder pin by moving the second mold in a horizontal direction; operating the fourth to sixth support pins formed in the second mold to support the inner magnet by being disposed in a triangular shape at intervals of 120° around the second holder pin based on the second holder pin according to a horizontal movement of the second mold; injecting resin into a resin inlet formed along a central portion of the first mold after the first mold and the second mold contact each other, and injecting the injected resin to surround the inner magnet; and solidifying the resin in a liquid state to complete the pick in which the inner magnet is disposed therein.

According to some embodiments of the present invention, wherein the inner magnet has a thickness of 0.2 to 0.3 mm and a diameter of 13 to 15 mm.

According to some embodiments of the present invention, wherein the first mold is fixed and the second mold is moved in a left and right direction.

According to some embodiments of the present invention, there is provided a pick for guitar performance manufactured by using the method of manufacturing a pick for guitar performance of any one of claims 1 to 3.

According to some embodiments of the present invention, wherein the pick includes a body part, an inner magnet, a center hole, and first to third peripheral holes, the body part is formed to have an isosceles triangle shape or a equilateral triangle shape, the inner magnet is formed inside the body part so as not to be exposed to the outside, the center hole is formed at a position corresponding to the center of gravity of the body part, and the first to third peripheral holes are arranged at a triangular shape with intervals of 120° with respect to the central hole.

Other specific details of the present invention are included in the detailed description and drawings.

According to the present invention, since the inner magnet is disposed inside the pick for guitar performance, the player can keep the picks on the peg of the rear surface of the guitar head and on the strings which have a magnetic body itself in a detachable manner. Accordingly, it is possible to reduce the loss of the pick, and the extra pick may be used immediately even when the pick is lost or broken.

In addition, according to the present invention, the plurality of picks are provided with different thicknesses, so that the plurality of picks can be variously selected and used according to the needs of the player. For example, a plurality of magnetic bodies may be formed on a peg of the rear surface of the guitar head, and picks having different thicknesses may be attached to each magnetic body.

In addition, according to the present invention, a plurality of picks are arranged to be sequentially increased in thickness to be attached to a magnetic body, and a player can easily select and use a pick having a required thickness.

The present invention has been made in efforts of the above effects, it is to be understood that the invention is not limited to the effects, it can be extended in various ways.

### BRIEF DESCRIPTION OF THE DRAWINGS

Several embodiments of the present disclosure will be provided, by way of examples only, with reference to the appended drawings, wherein:

FIGS. 1A and 1B are views showing picks for guitar performance according to an exemplary embodiment of the present invention;

FIG. 2 is a view for explaining a method of manufacturing picks for guitar performance according to an exemplary embodiment of the present invention; and

FIG. 3 is a view illustrating an operation in which picks for guitar performance according to an exemplary embodiment of the present invention are attached to a peg of a rear surface of a guitar head.

### DETAILED DESCRIPTION OF THE EMBODIMENTS

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and to convey the concept of the invention to those skilled in the art, but the present invention will only be defined by the appended claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “includes,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Hereinafter, with reference to the accompanying drawings, the preferred embodiments of the present invention will be described in more detail. In addition, for the same components on the drawing, the same reference numerals are used and redundant descriptions are omitted for the same constituent elements.

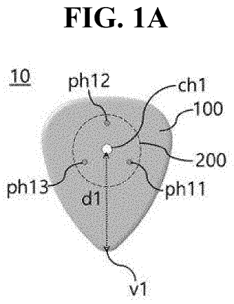

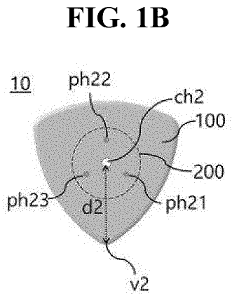

FIGS. 1A and 1B are views showing picks for guitar performance according to an exemplary embodiment of the present invention.

Referring to FIG. 1, the pick 10 for guitar performance according to the embodiment of the present invention includes a body part 100, an inner magnet 200, center holes ch1 and ch2, first to third peripheral holes ph11 to 13, and ph21 to 23.

The body part 100 of the pick 10 for guitar performance may be formed to have an isosceles triangle shape so that some vertices may be easily flicked as shown in FIG. 1A, or may be formed to have a regular triangle shape as shown in FIG. 1B. The body part 100 is formed to have an angle of less than 90°, and may be formed to include vertexes of a round shape and vertexes of a pointed shape as shown in FIG. 1A. Alternatively, the body part 100 may be formed to include three vertexes having a generally pointed shape as shown in FIG. 1B.

The body part 100 may be made of any one material selected from the group consisting of resin, plastic, rubber, and felt, and preferably, may be made of elastic material such as resin or plastic. Examples of the resin may include at least one material selected from the group consisting of polyurethane, polyester, lyocell, tencel, and spandex. Examples of the plastic may include, but are not limited to, celluloid, nylon, acetal, tortex, ultem, lexan, acryl, and the like.

The body part 100 includes an inner magnet 200. The inner magnet 200 may be, for example, a neodymium magnet. The inner magnet 200 may have a thickness of 0.2 to 0.3 mm and a diameter of 13 to 15 mm. In the case in which the thickness of the pick 10 is too thick, the thickness may be limited because it is inconvenient that the performer is picked up by hand, and the thickness of the inner magnet 200 may be 0.2 to 0.3 mm when considering the limitation of the thickness.

In addition, if the size of the inner magnet 200 is excessively large, the size of the body part 100 is also increased, and when the size of the inner magnet 200 is excessively small, the strength of the magnetic force is weak, such that the attachment/detachment function cannot be properly achieved, and thus the diameter may be 13 mm to 15 mm.

Since the inner magnet 200 is disposed at the pick 10, the player can attach the pick 10 according to the present invention to the magnetic body formed on the peg of the rear surface of the guitar head, and can be used for the performance by detaching the same if necessary. Accordingly, the performer can store the pick 10 without losing the pick 10, and can be used as a spare pick by attaching a plurality of picks 10 to the peg of the rear surface of the guitar head. In addition, a plurality of picks 10 may be provided as picks having different thicknesses, and thus, may be variously selected and used according to the needs of the performer. For example, a plurality of magnetic bodies may be formed on the peg of the rear surface of the guitar head, and one pick 10 may be attached to each magnetic body, and the different picks 10 may be appropriately used as necessary.

The pick 10 according to the present invention includes central holes ch1 and ch2 and first to third peripheral holes ph11 to 13 and ph21 to 23. The center holes ch1 and ch2 are formed at the center of the inner magnet 200 disposed in the body part 100 of the pick 10, and since the pins used to fix the inner magnet 200 are fixed to the center holes ch1 and ch2 when the pick 10 according to the present invention is manufactured according to the manufacturing method described below, the shape of the center holes ch1 and ch2 have remained.

As shown in FIG. 1A, the center hole ch1 is spaced apart from the first vertex v1 of the body part 100 by a first distance d1. In the pick 10 having the shape as shown in FIG. 1A, since the center of gravity is present at the rear end separated from the first vertex v1, the inner magnet 200 is disposed near the rear end separated from the first vertex v1. The first to third peripheral holes ph11, ph12, and ph13 may be formed at a position fixed by a pin supporting the inner magnet 200 in the process of manufacturing the pick 10 in the present invention, and for example, the first to third peripheral holes ph11, ph12, and ph13 may be disposed in a triangular with intervals at 120° with respect to the central hole ch1.

As shown in FIG. 1B, the center hole ch2 is spaced apart from the second vertex v2 of the body part 100 by a second distance d2. In the pick 10 having the shape as shown in FIG. 1B, since the center of gravity is almost the center point, the inner magnet 200 may exist at a point spaced apart from each vertex of the body part 100 by almost the same position, and accordingly, the center hole ch2 may be formed at the center of the body part 100 of the pick 10. The first to third peripheral holes ph21, ph22, and ph23 may be formed at a position fixed by a pin supporting the inner magnet 200 in the process of manufacturing the pick 10 in the present invention, and for example, the first to third peripheral holes ph21, ph22, and ph23 may be disposed in a triangular with intervals at 120° with respect to the central hole ch2.

As shown in FIGS. 1A and 1B, the inner magnet 200 may be disposed such that the center point of the inner magnet 200 corresponds to the center of gravity of the triangle with respect to the shape of the triangular pick 10. For example, three lines extending from each vertex based on a triangle shape meet at a center point of gravity, and the center point of gravity is located at a point dividing a length of a three lines by a ratio of 2:1 from a vertex. Since the inner magnet 200 is disposed at a position corresponding to the center point of gravity of the pick 10, the pick 10 may be stably attached to or detached from the magnetic body of the rear surface of the guitar head.

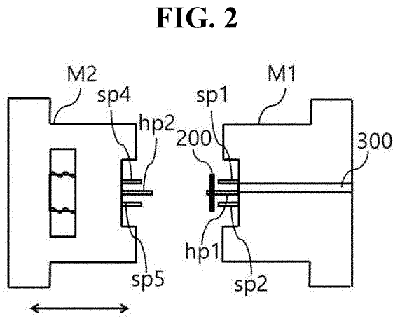

FIG. 2 is a view for explaining a method of manufacturing picks for guitar performance according to an exemplary embodiment of the present invention.

Referring to FIG. 2, in a method of manufacturing a pick 10 for guitar performance according to an exemplary embodiment of the present invention, first and second molds M1 and M2 respectively disposed on left and right sides of the inner magnet 200 are prepared, the first mold M1 is fixed, and the second mold M2 is arranged to perform left and right motions.

A first holder pin hp1 and a second holder pin hp2 are respectively formed at centers of the first mold M1 and the second mold M2, first to third support pins sp1 to sp3 are disposed around the first holder pin hp1, and fourth to sixth support pins sp4 to sp6 are disposed around the second holder pin hp2.

The inner magnet 200 is fixed to the first holder pin hp1, and for example, the inner magnet 200 may be a neodymium magnet. The inner magnet 200 may have a thickness of 0.2 to 0.3 mm and a diameter of 13 to 15 mm. When the inner magnet 200 is fixed to the first holder pin hp1, the first holder pin hp1 may protrude by about 1 mm.

The first to third support pins sp1 to sp3 are disposed at intervals of 120° around the first holder pin hp1, and are disposed in a triangular shape to support the inner magnet 200.

The second holder pin hp2 is formed at a position corresponding to the first holder pin hp1, and when the second mold M2 approaches the first mold M1 through left and right movement, the second holder pin hp2 contacts the first holder pin hp1 to support the inner magnet 200 to be fixed in a regular position. Similarly, the fourth to sixth supporting pins sp4 to sp6 are disposed at intervals of 120° around the second holder pin hp2, and are disposed in a triangular shape to support the inner magnet 200 when the first holder pin hp1 and the second holder pin hp2 contact each other.

After the first mold M1 and the second mold M2 approach each other, the resin is injected into the resin inlet 300 formed along the center portion of the first mold M1, the injected resin is formed to surround the inner magnet 200, and when the liquid resin is solidified, the pick 10 for guitar performance having the inner magnet 200 may be completed.

The first holder pin hp1, the second holder pin hp2, the first to third support pins sp1 to sp3, and the fourth to sixth support pins sp4 to sp6 may be appropriately disposed according to the shapes of the picks 10 to be manufactured, and the center holes ch1 and ch2 of the pick 10 are determined by positions of the first holder pin hp1 and the second holder pin hp2, and the first to third peripheral holes ph11 to 13 and ph21 to 23 are determined by positions of the first to third support pins sp1 to sp3 and the fourth to sixth support pins sp4 to sp6.

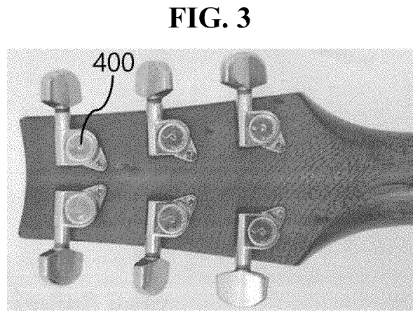

FIG. 3 is a view illustrating an operation in which picks for guitar performance according to an exemplary embodiment of the present invention are attached to a peg of a rear surface of a guitar head.

Referring to FIG. 3, the pick 10 according to the embodiment of the present invention is detachably attached to the magnetic body 400 formed on the rear surface of the guitar head, and the performer may prepare various kinds of picks 10 as necessary, and may keep the picks 10 together with the guitars without loss of the pick 10. In addition, even when the pick 10 is lost, that is, other pick 10 may be used, the performer may help to keep/manage the pick 10.

The plurality of magnetic bodies 400 may be sequentially formed on the rear surface of the guitar head, and the plurality of picks 10 may be sequentially disposed to increase the thickness and may be attached to the magnetic body 400. The performer may select and use an appropriate pick 10 as necessary, and may include a plurality of frequently used picks 10 to attach the pick 10 as an extra pick for loss or breakage.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present exemplary embodiments be considered in all respects as illustrative and not restrictive, reference being made to the appended claims rather than the foregoing description to indicate the scope of the invention.

What is claimed is:

1. A method of manufacturing a pick for guitar performance, the method comprising:
preparing a first mold and a second mold disposed to face each other in a horizontal direction;
mounting an inner magnet in a first holder pin formed in a central portion of the first mold;
disposing the inner magnet to support the inner magnet by using first to third support pins formed in the first mold and disposed in a triangular shape at intervals of 120° around the first holder pin based on the first holder pin;
operating the second mold so that a second holder pin formed at a central portion of the second mold contacts the first holder pin by moving the second mold in a horizontal direction;
operating the fourth to sixth support pins formed in the second mold to support the inner magnet by being disposed in a triangular shape at intervals of 120° around the second holder pin based on the second holder pin according to a horizontal movement of the second mold;
injecting resin into a resin inlet formed along a central portion of the first mold after the first mold and the second mold contact each other, and injecting the injected resin to surround the inner magnet; and
solidifying the resin in a liquid state to complete the pick in which the inner magnet is disposed therein.

2. The method of claim 1, wherein the inner magnet has a thickness of 0.2 to 0.3 mm and a diameter of 13 to 15 mm.

3. The method of claim 1, wherein the first mold is fixed and the second mold is moved in a left and right direction.

4. A pick for guitar performance manufactured by using the method of manufacturing a pick for guitar performance of any one of claims 1 to 3.

5. The pick of claim 4, wherein the pick includes a body part, an inner magnet, a center hole, and first to third peripheral holes, the body part is formed to have an isosceles triangle shape or a equilateral triangle shape, the inner magnet is formed inside the body part so as not to be exposed to the outside, the center hole is formed at a position corresponding to the center of gravity of the body part, and the first to third peripheral holes are arranged at a triangular shape with intervals of 120° with respect to the central hole.
